(19) United States
(12) Patent Application Publication
(10) Pub. No.: US 2022/0078869 A1
(43) Pub. Date: Mar. 10, 2022

(54) CONTROL DEVICE AND NON-TRANSITORY COMPUTER READABLE STORAGE MEDIUM

(71) Applicant: KABUSHIKI KAISHA TOKAI RIKA DENKI SEISAKUSHO, Aichi (JP)

(72) Inventors: Masateru FURUTA, Aichi (JP); Shigenori NITTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/400,563

(22) Filed: Aug. 12, 2021

(30) Foreign Application Priority Data
Sep. 7, 2020 (JP) 2020-149661

(51) Int. Cl. H04W 76/18; H04L 1/18; H04W 72/04; H04W 28/04

(52) U.S. Cl. CPC H04W 76/18; H04W 28/04; H04W 72/0453; H04L 1/189

(57) ABSTRACT

To increase the probability of improving a communication state related to wireless communication.

There is provided a control unit configured to control wireless communication conforming to a specific communication standard by a wireless communication unit, wherein for controlling execution of a retry related to the wireless communication conforming to the specific communication standard, the control unit controls the wireless communication unit to execute the retry using signals corresponding to a channel different from a channel used before execution of the retry.

### CROSS REFERENCE TO RELATED APPLICATION(S)

This application is based upon and claims benefit of priority from Japanese Patent Application No. 2020-149661, filed on Sep. 7, 2020, the entire contents of which are incorporated herein by reference.

### BACKGROUND

The present invention relates to a control device and a non-transitory computer readable storage medium.

Recently, there has been developed a technology of performing various kinds of processing in accordance with results of transmission and reception of wireless signals between devices. For example, Patent Literature 2020-118030 discloses a technology of measuring a distance between devices using ultra wide band (UWB) signals.

### SUMMARY

In the above-described system using wireless signals, it is normal that signals corresponding to a preliminarily specified channel are transmitted and received. However, in a case where the same channel is used fixedly, the communication state may not be improved even with a retry.

In view of the above-described problem, the present invention aims at increasing the probability of improving a communication state related to wireless communication.

To solve the above described problem, according to an aspect of the present invention, there is provided a control device, comprising: a control unit configured to control wireless communication conforming to a specific communication standard by a wireless communication unit, wherein for controlling execution of a retry related to the wireless communication conforming to the specific communication standard, the control unit controls the wireless communication unit to execute the retry using signals corresponding to a channel different from a channel used before execution of the retry.

To solve the above described problem, according to another aspect of the present invention, there is provided a control device, comprising: a control unit configured to control wireless communication conforming to a specific communication standard by a wireless communication unit, wherein the control unit controls the wireless communication unit to transmit signals corresponding to a directivity and a channel in accordance with a direction of a device of a communication destination that performs wireless communication conforming to the specific communication standard with the wireless communication unit.

To solve the above described problem, according to another aspect of the present invention, there is provided a non-transitory computer readable storage medium storing a program, the program controlling a computer to achieve: a control function for controlling wireless communication conforming to a specific communication standard by a wireless communication unit, wherein the control function is controlled to perform a control such that the wireless communication unit transmits signals corresponding to a directivity and a channel in accordance with a direction of a device of a communication destination that performs wireless communication conforming to the specific communication standard with the wireless communication unit.

In the present invention described above, it is possible to increase the probability of improving a communication state related to wireless communication.

### BRIEF DESCRIPTION OF THE DRAWINGS

FIG. 1 is a block diagram for explaining a function configuration example of a control device 10 according to an embodiment of the invention.

FIG. 2 is a diagram exemplifying the relation between the channel and the directivity of signals according to the embodiment.

FIG. 3 is a diagram for explaining a control in accordance with the direction of a device of a communication destination according to the embodiment.

FIG. 4 is a flowchart illustrating an example of a flow of the control by the control device 10 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

1.1. Function Configuration Example of Control Device 10

First, a function configuration example of the control device 10 according to an embodiment of the invention will be described.

The control device 10 of the embodiment is a device that controls wireless communication conforming to a specific communication standard by a wireless communication unit to be controlled.

For example, the control device 10 of the embodiment may be provided in a mobile body such as a vehicle, and control a wireless communication unit provided in the mobile body.

Moreover, for example, the control device 10 of the embodiment may be provided in a mobile terminal such as a smartphone or a dedicated device, and control a wireless communication unit provided in the mobile terminal.

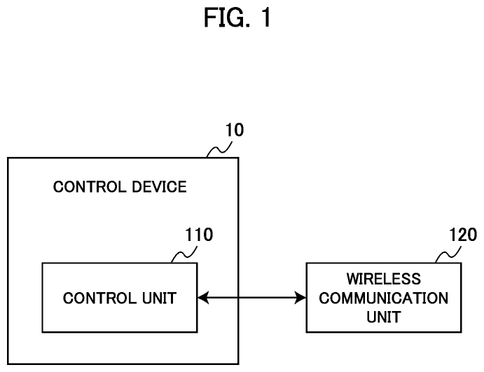

FIG. 1 is a block diagram for explaining a function configuration example of the control device 10 according to the embodiment. As illustrated in FIG. 1, the control device 10 of the embodiment includes a control unit 110.

Control Unit 110

The control unit 110 of the embodiment controls wireless communication conforming to a specific communication standard by a wireless communication unit.

The examples of the specific communication standard according to the embodiment include ultra wide band wireless communication. In this case, the control unit 110 of the embodiment controls transmission and reception of ultra wide band signals (hereinafter, also referred to as UWB signals) performed by a wireless communication unit 120.

Meanwhile, the specific communication standard according to the embodiment is not limited to the above-described example. The specific communication standard of the embodiment may be, for example, Bluetooth (registered trademark) Low Energy (BLE), or wireless communication using low frequency (LF) band and ultra high frequency (UHF) band signals. Even in such a case, the communication unit 110 of the embodiment controls transmission and reception of signals conforming to the specific communication standard performed by the wireless communication unit 120.

Moreover, the control unit 110 of the embodiment controls execution of a retry related to wireless communication conforming to the above-described specific communication standard. Here, the retry includes reexecution of transmission and reception of signals for improving a communication state related to wireless communication, or the like.

For example, the control unit 110 of the embodiment may control the wireless communication unit 120 to execute a retry related to wireless communication conforming to the specific communication standard, when the wireless communication unit 120 cannot receive signals conforming to the specific communication standard.

As an example, in a case where the wireless communication conforming to the specific communication standard is ultra wide band wireless communication, when the control unit 110 controls the wireless communication unit 120 to transmit UWB signals and then the wireless communication unit 120 cannot receive a reply from a device of a communication destination, the control unit 110 may control the wireless communication unit 120 to transmit UWB signals again.

Moreover, for example, when the reception strength of signals conforming to the specific communication standard received by the wireless communication unit 120 is lower than a threshold, the control unit 110 of the embodiment may control the wireless communication unit 120 to execute a retry related to the wireless communication conforming to the specific communication standard.

As an example, in a case where the wireless communication conforming to the specific communication standard is ultra wide band wireless communication, the control unit 110 may control the wireless communication unit 120 to transmit UWB signals again when the reception strength of UWB signals received by the wireless communication unit 120 is lower than a threshold.

Note that the functions of the control unit 110 of the embodiment are achieved by a processor such as a central processing unit (CPU).

Wireless Communication Unit 120

The wireless communication unit 120 of the embodiment performs wireless communication conforming to the specific communication standard, in accordance with the control by the control unit 110.

For example, the wireless communication unit 120 of the embodiment may transmit signals conforming to the specific communication standard or stand by to receive signals conforming to the specific communication standard, in accordance with the control by the control unit 110.

Moreover, the wireless communication unit 120 of the embodiment executes a retry related to wireless communication conforming to the specific communication standard, in accordance with the control by the control unit 110.

The above has described the function configuration example of the control device 10 of the embodiment, and the overview of the functions of the wireless communication unit 120.

Note that the function configuration of the control device 10 illustrated in FIG. 1 is an example, and the function configuration of the control device 10 of the embodiment is not limited to such an example. For example, the control unit 110 and the wireless communication unit 120 of the embodiment may be provided in the same device. The function configuration of the control device 10 of the embodiment can be modified flexibly depending on specifications and uses.

1.2. Details

The following will specifically describe the control functions of the control device 10 of the embodiment.

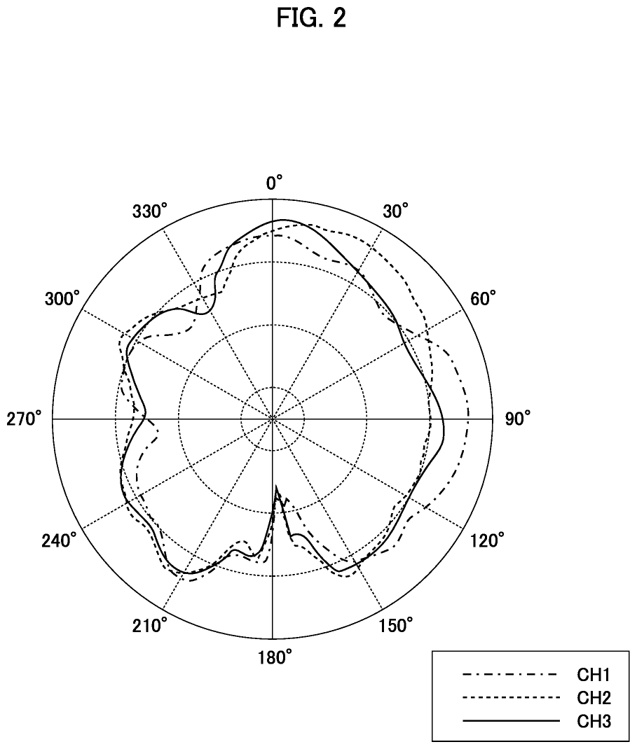

Here, the relation between the channel used for wireless communication and the directivity of signals will be described first. FIG. 2 is a diagram exemplifying the relation between the channel and the directivity of signals.

FIG. 2 illustrates the directivities of a signal corresponding to each of channels CH1 to CH3 in the surrounding circumference of 360° with the position of an antenna of the wireless communication unit 120 as a center.

As exemplified in FIG. 2, the directivity of a signal is different for each channel even with the same communication standard.

For example, in the case of the example illustrated in FIG. 2, the signal corresponding to the channel CH2 is propagated to the farthest in the direction of 30° from the wireless communication unit 120, while the signal corresponding to the channel CH1 is propagated to the farthest in the direction of 90° from the wireless communication unit 120.

Such a directivity is strongly influenced by noises, a multipath, and the like. For example, when the signals corresponding to the same channel are used, the same multipath environment is established as long as an object shielding between the wireless communication unit 120 and a device of a communication destination does not move. Here, when a multipath related to signals transmitted from the wireless communication unit 120 does not reach a device of a communication destination, communication is not established while the same channel is used.

Moreover, for example, when noises corresponding to the channel used for wireless communication exit in the environment and the same channel continues to be used, the channel is continuously interfered unless the noises disappear.

The technical ideas of the present invention have been made in view of the above-described aspects, and increase the probability of improving a communication state related to wireless communication.

For this, the control unit 110 of the embodiment is characterized in performing a control of execution of a retry such that the retry is executed using signals corresponding to a channel different from the channel used before execution of the retry, that is, the channel used in wireless communication determined to require improvement of a communication state.

With the above-described control, the multipath environment is changed for every retry and the directivity of a signal is then changed, which increases the probability of improving a communication state related to wireless communication.

Moreover, with the above-described control, even while noises have negative influences on communication, the channel may be changed to a channel not influenced by the noises, which increases the probability of improving a communication state.

Note that for the control of execution of a retry, the control unit 110 of the embodiment may control the wireless communication unit 120 to execute a retry using signals corresponding to a preliminarily specified channel.

For example, the control unit 110 may control the wireless communication unit 120 to execute a retry using signals corresponding to each of the channels CH1, CH2, CH3 sequentially for every retry.

Meanwhile, for the control of execution of a retry, the control unit 110 of the embodiment may control the wireless communication unit 120 to share the information related to a channel after a change with a device of a communication destination through wireless communication conforming to another communication standard that is different from the wireless communication conforming to the specific communication standard.

For example, in a case where the specific communication standard is ultra wide band wireless communication, the above-described another communication standard may be BLE or wireless communication using LF band and UHF band signals, for example. As an example, the control unit 110 may control the wireless communication unit 120 to transmit the information related to a channel used for a retry of ultra wide band wireless communication, using LF band signals.

In such a case, the control unit 110 may control the wireless communication unit 120 to transmit the information related to a channel used for a retry, and then control the wireless communication unit 120 to execute a retry using signals corresponding to the channel.

The channels used for a retry in the embodiment may be set so that the bands of the channels do not overlap one another.

For example, in a case where the specific communication standard is ultra wide band wireless communication, 6.25 to 6.75 GHz, 6.75 to 7.25 GHz, 7.25 to 7.75 GHz, 7.75 to 8.25 GHz, or the like may be used for the channels.

With the above-described setting, the degree of changing a multipath environment is increased, whereby it is possible to further increase the probability of improving a communication environment.

Meanwhile, the above-described setting is an example, and the setting of the channels in the embodiment is not limited to such an example. The channels of the embodiment can be set flexibly in accordance with the regulations in each country or region.

The above has described that the control unit 110 of the embodiment controls the wireless communication unit 120 to execute wireless communication using a channel different for every retry.

The following will describe a control in accordance with the direction of a device of a communication destination that performs wireless communication conforming to the specific communication standard with the wireless communication unit 120.

The control unit 110 of the embodiment may perform a control in accordance with the direction of a device of a communication destination, in addition to the above-described control of a retry or independently.

To be more specific, the control unit 110 of the embodiment may control the wireless communication unit 120 to transmit signals corresponding to the directivity and the channel in accordance with the direction of a device of a communication destination.

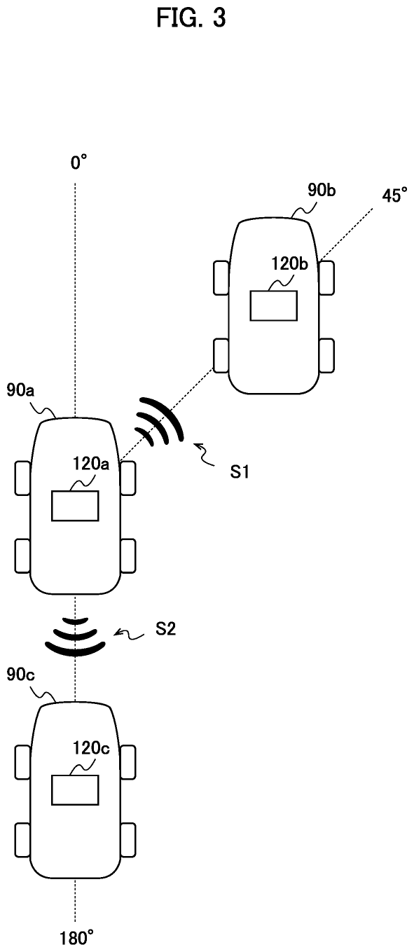

FIG. 3 is a diagram for explaining a control in accordance with the direction of a device of a communication destination according to the embodiment. FIG. 3 illustrates, as an example, the position relation among a wireless communication unit 120a provided in a vehicle 90a, a wireless communication unit 120b provided in a vehicle 90b, and a wireless communication unit 120c provided in a vehicle 90c.

In such a case, a control unit 110a (not illustrated) provided in the vehicle 90a may perform a control in accordance with the direction (relative to the wireless communication unit 120a) of the wireless communication unit 120b or the wireless communication unit 120c that is a device of a communication destination of the wireless communication unit 120a to be controlled.

For example, there is assumed the case where the wireless communication unit 120b is positioned in the direction of 45° from the wireless communication unit 120a and the wireless communication unit 120c is positioned in the direction of 180° from the wireless communication unit 120a, as illustrated in FIG. 3.

In this case, the control unit 110a may control the wireless communication unit 120a to transmit a signal S1 having the directivity in the direction of 45°.

Moreover, the control unit 110a may control the wireless communication unit 120a to transmit a signal S2 having the directivity in the direction of 180°

To achieve the above, the wireless communication unit 120a may include a mobile antenna capable of changing the directivity related to the direction of a signal to be transmitted.

Meanwhile, the wireless communication unit 120a may include a plurality of antennas having directivities in mutually different directions, and transmit signals using an antenna having the directivity corresponding to the direction of a device of a communication destination, in accordance with the control by the control unit 110a.

Moreover, in the case of the example illustrated in FIG. 3, the control unit 110 may control the wireless communication unit 120 to transmit the signal S1 and the signal S2 corresponding to mutually different channels.

With the above-described control, the wireless communication between the wireless communication unit 120a and the wireless communication unit 120b and the wireless communication between the wireless communication unit 120a and the wireless communication unit 120c can use signals of mutually different frequencies. Thus, it is possible to clearly distinguish received signals even when both of wireless communication are performed at the same time.

1.3 Flow of Control

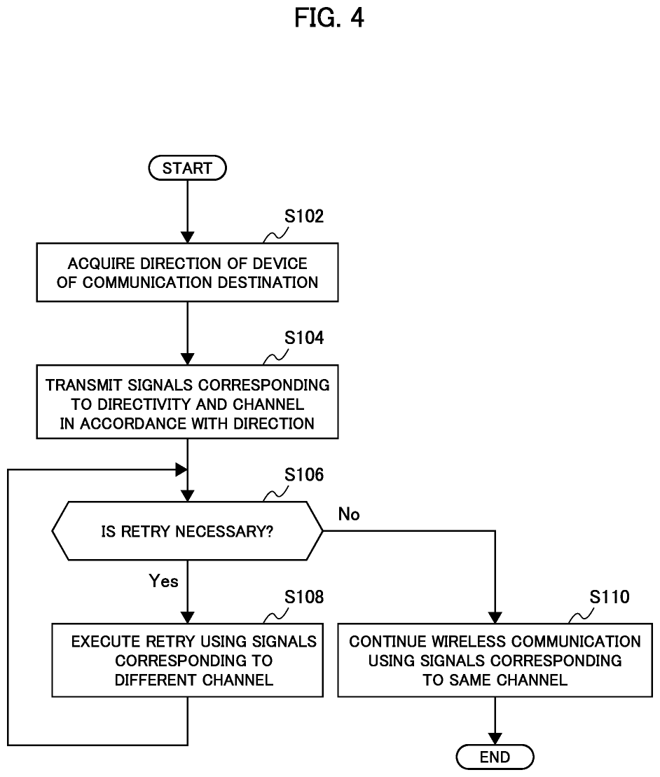

The following will specifically describe a flow of the control by the control device 10 according to the embodiment. FIG. 4 is a flowchart illustrating an example of a flow of the control by the control device 10 according to the embodiment.

Note that FIG. 4 exemplifies a flow of the case where the control device 10 performs a control in accordance with the direction of a device of a communication destination, at the same time as a retry control.

In this case, the control unit 110 of the control device 10 first acquires a direction of a device of a communication destination that performs wireless communication conforming to a specific communication standard with the wireless communication unit 120 to be controlled (S102).

For example, the direction of a device of a communication destination may be acquired by arrival angle estimation based on a phase difference of signals received by two antennas of the wireless communication unit 120. Note that such signals may be signals conforming to the specific communication standard or signals conforming to another communication standard.

Moreover, for example, the direction of the device of a communication destination may be estimated on the basis of images or the like acquired by a camera provided together with the control device 10 and the wireless communication unit 120 in a vehicle or the like.

Next, the control unit 110 controls the wireless communication unit 120 to transmit signals corresponding to the directivity and the channel in accordance with the direction of the device of a communication destination that is acquired at Step S102 (S104).

Next, the control unit 110 determines whether to control the wireless communication unit 120 to execute a retry related to the wireless communication (S106).

Here, the control unit 110 may determine that a retry is necessary on the basis of a fact that the wireless communication unit 120 cannot receive signals conforming to the specific communication standard, or determine that a retry is necessary on the basis of a fact that the reception strength of signals conforming to the specific communication standard received by the wireless communication unit 120 is lower than a threshold.

When it is determined that a retry is necessary (Yes at S106), the control unit 110 controls the wireless communication unit 120 to execute a retry related to the wireless communication using signals corresponding to a channel different from the channel used at Step S104 (S108).

Moreover, after the control at Step S108, the processing returns to Step S106 where the control unit 110 performs again determination related to whether a retry is necessary.

Meanwhile, when it is determined that a retry is not necessary (No at Step S106), the control unit 110 controls the wireless communication unit 120 to continue to perform wireless communication using signals corresponding to the channel used at Step S104 (S110).

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

A sequence of processing by the devices described in the specification may be achieved using any one of software, hardware, and the combination of software and hardware. A program forming the software is preliminarily stored in a non-transient computer readable storage medium provided inside or outside the devices, for example. Then, each program is read in a random access memory (RAM) when executed by a computer, and executed by a processor such as a CPU. The above-described recording medium is, for example, a magnetic disk, an optical disk, a magneto-optical disk, a flash memory, or the like. Moreover, the above-described computer program may be distributed through a network, for example, without using any recording medium.

What is claimed is:

1. A control device, comprising:
a control unit configured to control wireless communication conforming to a specific communication standard by a wireless communication unit, wherein
for controlling execution of a retry related to the wireless communication conforming to the specific communication standard, the control unit controls the wireless communication unit to execute the retry using signals corresponding to a channel different from a channel used before execution of the retry.

2. The control device according to claim 1, wherein for controlling execution of the retry, the control unit controls the wireless communication unit to execute the retry using signals corresponding to a preliminarily specified channel.

3. The control device according to claim 1, wherein for controlling execution of the retry, the control unit controls the wireless communication unit to share information related to a channel after a change with a device of a communication destination through wireless communication conforming to another communication standard that is different from the wireless communication conforming to the specific communication standard.

4. The control device according to claim 1, wherein the control unit controls the wireless communication unit to execute the retry related to the wireless communication conforming to the specific communication standard, when the wireless communication unit cannot receive signals conforming to the specific communication standard.

5. The control device according to claim 1, wherein the control unit controls the wireless communication unit to execute the retry related to the wireless communication conforming to the specific communication standard, when a reception strength of signals conforming to the specific communication standard is lower than a threshold.

6. The control device according to claim 1, wherein the control unit controls the wireless communication unit to transmit signals corresponding to a directivity and a channel in accordance with a direction of a device of a communication destination.

7. The control device according to claim 1, wherein the specific communication standard includes ultra wide band wireless communication.

8. The control device according to claim 7, wherein channels are set so that bands of the channels do not overlap one another.

9. A control device, comprising:
a control unit configured to control wireless communication conforming to a specific communication standard by a wireless communication unit, wherein
the control unit controls the wireless communication unit to transmit signals corresponding to a directivity and a channel in accordance with a direction of a device of a communication destination that performs wireless communication conforming to the specific communication standard with the wireless communication unit.

10. A non-transitory computer readable storage medium storing a program, the program controlling a computer to achieve:
a control function for controlling wireless communication conforming to a specific communication standard by a wireless communication unit, wherein
the control function is controlled to perform a control such that the wireless communication unit transmits signals corresponding to a directivity and a channel in accordance with a direction of a device of a communication destination that performs wireless communication conforming to the specific communication standard with the wireless communication unit.
